(19) United States
(12) Patent Application Publication
(10) Pub. No.: US 2010/0313911 A1
(43) Pub. Date: Dec. 16, 2010

(54) USE OF OPEN-CELL FOAMS IN VACUUM CLEANERS

(75) Inventors: Ulf Baus, Dossenheim (DE); Stefan Frenzel, Mannheim (DE); Bernhard Vath, Mannheim (DE); Christof Moeck, Mannheim (DE); Stefan Tiekoetter, Bielefeld (DE); Andre Bertram, Bielefeld (DE); Joerg Kinnius, Spenge (DE); Cornelius Wolf, Bielefeld (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: Basf SE, Ludwigshafen (DE)

(21) Appl. No.: 12/446,536

(22) PCT Filed: Oct. 23, 2007
(86) PCT No.: PCT/EP2007/061332

§ 371 Date: Apr. 21, 2009

(30) Foreign Application Priority Data
Oct. 27, 2006 (DE) 102006051404.1

(51) Int. Cl. B08B 5/04; A47L 9/00; A47L 9/10; B01D 46/00

(52) U.S. Cl. 134/21; 15/300.1; 55/522

(57) ABSTRACT

Use of moldings with length·width·height dimensions respectively in the range from 1 mm to 3 cm as dust binders in vacuum cleaners, where the molding(s) has/have been produced from chemically untreated open-cell foam whose density is in the range from 5 to 500 kg/m³ and whose average pore diameter is in the range from 1 μm to 1 mm.

The present invention relates to the use of moldings with length·width·height dimensions respectively in the range from 1 mm to 3 cm as dust binders in vacuum cleaners, where the molding(s) has/have been produced from chemically untreated open-cell foam whose density is in the range from 5 to 500 kg/m³ and whose average pore diameter is in the range from 1 μm to 1 mm.

The present invention further relates to vacuum cleaners, encompassing moldings characterized above.

Foams, specifically those known as open-cell foams, are used in numerous applications. In particular, open-cell foams composed of synthetic materials have proven versatile. Examples that may be mentioned are seat cushions, filter materials, air-conditioning systems and automobile parts, and also cleaning materials.

Vacuum cleaners, especially those used for floors, often use dust-retention systems arranged between the air inlet of a dust collection space and the suction side of a fan, which retain the dust prior to entry into the fan. One particularly known variant is a filter shaped as a bag, the inner side of which is exposed to the dust, i.e. the dust forms a deposit in the interior of the filter shaped as a bag. Such filters require regular replacement. Some vacuum cleaners, in particular microvacuum cleaners, multipurpose vacuum cleaners, or industrial equipment, have filters which surround the fan and whose outer side is exposed to the dust. An advantage of these is greater absorption capacity; a disadvantage is that such filters are designed only for coarse dust, while fine dust, which can include allergenic pollen and microorganisms, passes through this filter and is blown back by the fan into the space requiring vacuum cleaning, the actual result being raising of the dust.

Alongside the vacuum cleaners described above, having a bag, there are those known as “bagless vacuum cleaners” which operate with no dust bag. They generally comprise a cyclone for dust separation or preliminary dust deposition, and a downstream fine dust filter. A disadvantage of bagless systems known hitherto is that emptying of the cyclone—mostly by way of a valve on the base of the dust collection container—produces a dust cloud, which is an unhygienic aspect of said system.

It was an object to provide a dust binder which is particularly suitable for use in vacuum cleaners and which by way of example has high dust-accumulation capacity, where its arrangement is hygienically entirely satisfactory, and which is capable of binding fine dust. A further object was to provide a process for the production of dust binders of the invention.

Accordingly, the use defined in the introduction has been found for moldings.

According to the invention, one, or preferably at least two, molding(s) with length·width·height dimensions respectively in the range from 1 mm to 3 cm is/are used as dust binders in vacuum cleaners, where the moldings have been produced from chemically untreated open-cell foam whose density is in the range from 5 to 500 kg/m³ and whose average pore diameter is in the range from 1 μm to 1 mm.

The length·width·height dimensions on moldings used according to the invention are respectively in the range from 1 mm to 3 cm, and at least one dimension here, i.e. length or width or height, is greater than 5.5 mm. It is also possible that two or all three of the dimensions are greater than 5.5 mm.

In one embodiment of the present invention, moldings of the invention take the form of cylinders, square columns, saddles, spheres, flakes, granules, blocks, or cubes, preferably being shaped as tablets or sliced material (pellets), or else take the form of stars, letters of the alphabet, or hedgehog-shaped moldings, or moldings comprising cavities.

In one embodiment of the present invention, at least two moldings are used, for example from two to twenty, in particular from two to five. In one preferred embodiment, the moldings used according to the invention for this purpose are of approximately the same size i.e. dimensions can vary by up to ±10%.

Production of moldings used according to the invention starts from open-cell foam.

In one embodiment of the present invention, open-cell foams used according to the invention are those based on synthetic organic foam, examples being foams based on polyurethane foams or on aminoplastic foams, for example composed of urea-formaldehyde resins, and also foams based on phenol-formaldehyde resins and in particular foams based on polyurethanes or on aminoplastic-formaldehyde resins, in particular on melamine-formaldehyde resins, and for the purposes of the present invention foams based on polyurethanes are also termed polyurethane foams, and foams based on melamine-formaldehyde resins are also termed melamine foams.

This means that moldings used according to the invention are produced from open-cell foams which comprise synthetic organic materials, preferably polyurethane foams or aminoplastic foams, and in particular melamine foams.

The unmodified open-cell foams used for the production of moldings of the invention are very generally also termed unmodified foams for the purposes of the present invention. The unmodified open-cell foams (a) used for conduct of the process of the invention are described in more detail below.

Open-cell foams are used as starting material for conduct of the production process of the invention, in particular foams in which at least 50% of all of the cell walls are open, preferably from 60 to 100%, and particularly preferably from 65 to 99.9%, determined to DIN ISO 4590.

Foams used as starting material are preferably rigid foams, and for the purposes of the present invention these are foams whose compressive hardness, determined to DIN 53577, is 1 kPa or more for 40% compression.

The density of foams used as starting material is in the range from 3 to 500 kg/m³, preferably from 6 to 300 kg/m³, and particularly preferably in the range from 7 to 300 kg/m³.

The average pore diameter (number average) of open-cell foams used as starting material can be in the range from 1 μm to 1 mm, preferably from 50 to 500 μm, determined by evaluating micrographs of sections.

In one embodiment of the present invention, open-cell foams used as starting material can have a maximum of 20, preferably a maximum of 15, and particularly preferably a maximum of 10, pores per m² whose diameter is in the range up to 20 mm. The diameter of the other pores is usually smaller.

In one embodiment of the present invention, the BET surface area of open-cell foams used as starting material is in the range from 0.1 to 50 m²/g, preferably from 0.5 to 20 m²/g, determined to DIN 66131.

In one embodiment of the present invention, the starting material used comprises open-cell foams composed of synthetic organic material, and preferably comprises melamine foams.

Melamine foams particularly suitable as starting material for carrying out the production process of the invention are known per se. An example of a successful method of production uses foaming of
i) a melamine-formaldehyde precondensate which can comprise not only formaldehyde but also further cocondensed carbonyl compounds, such as aldehydes,
ii) one or more blowing agents,
iii) one or more emulsifiers, and
iv) one or more curing agents.

Melamine-formaldehyde precondensates i) can be unmodified materials, but they can also be modified materials, and by way of example up to 20 mol % of the melamine can have been replaced by other thermoset-formers known per se, an example being alkyl-substituted melamine, and other examples being urea, urethane, carboxamides, dicyandiamide, guanidine, sulfurylamide, sulfonamides, aliphatic amines, phenol, and phenol derivatives. Modified melamine-formaldehyde precondensates can comprise by way of example, as further carbonyl compounds alongside formaldehyde, acetaldehyde, trimethylolacetaldehyde, acrolein, furfural, glyoxal, phthalaldehyde and terephthalaldehyde.

Suitable blowing agents ii) are: water, inert gases, in particular carbon dioxide, and those known as physical blowing agents. Physical blowing agents involve compounds which are inert toward the starting components and which are mostly liquid at room temperature, and which vaporize under the conditions of the urethane reaction. The boiling point of said compounds is preferably below 110° C., in particular below 80° C. Among the physical blowing agents are also inert gases which are introduced into or dissolved into the starting components i) and ii), an example being carbon dioxide, nitrogen, or noble gases.

Suitable compounds which are liquid at room temperature are mostly selected from the group consisting of alkanes and/or cycloalkanes having at least 4 carbon atoms, dialkyl ethers, esters, ketones, acetals, fluoroalkanes having from 1 to 8 carbon atoms, and tetraalkylsilanes having from 1 to 3 carbon atoms in the alkyl chain, in particular tetramethylsilane.

Examples that may be mentioned are: propane, n-butane, iso- and cyclobutane, n-, iso-, and cyclopentane, cyclohexane, dimethyl ether, methyl ethyl ether, methyl tert-butyl ether, methyl formate, acetone, and also fluorinated alkanes which can be degraded in the troposphere and therefore do not damage the ozone layer, e.g. trifluoromethane, difluoromethane, 1,1,1,3,3-pentafluorobutane, 1,1,1,3,3-pentafluoropropane, 1,1,1,2-tetrafluoroethane, 1,1,1-trifluoro-2,2,2-trichloroethane, 1,1,2-trifluoro-1,2,2-trichloroethane, difluoroethanes, and heptafluoropropane. The physical blowing agents mentioned can be used alone or in any desired combination with one another.

EP-A 0 351 614 discloses the use of perfluoroalkanes for producing open cells.

Emulsifiers iii) used can be customary nonionic, anionic, cationic, or betainic surfactants, in particular C₁₂-C₃₀-alkyl sulfonates, preferably C₁₂-C₁₈-alkyl sulfonates, and polyethoxylated C₁₀-C₂₀-alkyl alcohols, in particular of the formula R¹—O(CH₂—CH₂—O)_{y}—H, where R¹ is selected from C₁₀-C₂₀-alkyl, and y can by way of example be a whole number in the range from 5 to 100.

Particular curing agents iv) that can be used are acidic compounds, such as inorganic Brønstedt acids, e.g. sulfuric acid or phosphoric acid, organic Brønstedt acids, such as acetic acid or formic acid, Lewis acids, and also compounds known as latent acids.

EP-A 0 017 672 reveals examples of suitable melamine foams.

Foams used as starting material can naturally comprise additives conventional in foam chemistry, for example antioxidants, flame retardants, fillers, colorants, such as pigments or dyes, and biocides, for example

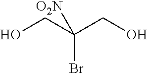

Further examples of biocides are silver particles or monomeric or polymeric organic biocides, such as phenoxyethanol, phenoxypropanol, glyoxal, thiadiazines, 2,4-dichlorobenzyl alcohols and preferably isothiazolone derivatives, e.g. MIT (2-methyl-3(2H)-isothiazolone), OMIT (5-chloro-2-methyl-3(2H)-isothiazolone), CIT (5-chloro-3(2H)-isothiazolone), BIT (1,2-benzoisothiazol-3(2H)-one), and also copolymers of N,N-di-C₁-C₁₀-alkyl-ω-amino-C₂-C₄-alkyl (meth)acrylate, in particular copolymers of ethylene with N,N-di-methyl-2-aminoethyl(meth)acrylate.

Examples of Fillers Are:

Activated charcoal, colorants such as dyes or pigments, fragrances such as parfum and odor scavengers, such as cyclodextrins.

In an example of a procedure for the introduction of additives, at least one chemically unmodified foam is brought into contact in various operations or preferably simultaneously with an aqueous formulation of at least one additive. The material can then be dried.

In one embodiment of the present invention, this type of aqueous formulation comprises proportions of from 0 to a total of 50% by weight, based on foam, preferably from 0.001 to 30% by weight, particularly preferably from 0.01 to 25% by weight, very particularly preferably from 0.1 to 20% by weight of one or more additives.

For the production of moldings used according to the invention, it is moreover possible to carry out one or more mechanical compressions after the aqueous formulation of at least one additive has been allowed to interact with unmodified foam. The mechanical compression can be carried out batchwise or preferably continuously, for example batchwise by presses or platens, or for example continuously by rolls or calenders. If calendering is desired, one or more calender passes can be carried out, for example from one to twenty calender passes, preferably from five to ten calender passes.

In one embodiment of the present invention, mechanical compression is carried out until the degree of compaction is in the range from 1:1.2 to 1:12, preferably from 1:2.5 to 1:5.

In one embodiment of the present invention, the material is calendered prior to drying.

The procedure in one embodiment of the present invention is that, after an aqueous formulation of at least one additive has been brought into contact with the material and the materials have been allowed to interact, the product is then dried, and then moistened with water, and then mechanically compressed, for example calendered.

A possible procedure in one embodiment of the present invention is that, after an aqueous formulation of additive has been brought into contact with, and allowed to interact with, unmodified foam, the materials can be heat-set, and specifically prior to or after the mechanical compression, or else between two mechanical-compression steps. By way of example, heat-setting can be carried out at temperatures of from 120° C. to 250° C. for a period of from 5 seconds up to 5 minutes. Examples of suitable apparatuses are microwave ovens, platen presses, with use of hot-air blowers, drying ovens heated electrically or by gas flames, heated roll mills, or continuously operated drying equipment.

Prior to the heat-setting, drying may be carried out, as described above.

At least one shaping step is carried out for the production of moldings of the invention. The contact with an aqueous formulation of additive—if this step is desired—then the shaping step can be carried out in any desired sequence. It is preferable here to begin with contact with an aqueous formulation of additive—if this step is desired—and then to carry out the shaping step.

In one embodiment of the present invention, the shaping step is carried out mechanically, for example by milling, shredding, or granulating, and preferably by lacerating correspondingly larger parts, or by stamping, or by cutting.

In another embodiment of the present invention, unmodified foam is produced in the form of a molding with the dimensions defined in the introduction, and in particular the foaming can be carried out in molds, thus giving moldings of chemically unmodified foam, which can then be brought into contact with an aqueous formulation of additive.

Moldings described above can by way of example be used as dust binders in vacuum cleaners, and specifically in such a way that they are not fixedly incorporated into the relevant vacuum cleaner but instead move within certain limits within the relevant vacuum cleaner during the operation of the vacuum cleaner.

Moldings of the invention can be used as dust binders in particular in what are known as bagless vacuum cleaners.

For the purposes of the present invention, dust binders are capable of binding coarse dust and preferably also the fine dust sucked into the vacuum cleaner, partially or preferably to a predominant extent, for example more than 50% by weight.

An example of a procedure for the use of moldings described above as dust binders can be as follows:

A vacuum cleaner is provided, in particular a bagless vacuum cleaner, having a dust collection container located within the air stream. The dust collection container can take the form of a cyclone, for example.

In one embodiment of the present invention, a plurality of moldings are directly fed into the dust collection container. The material is fed by using one or more feeders, which can have been integrated within the vacuum cleaner or within a suction attachment, or can take the form of external apparatus with a receiver for the dust collection container. There is therefore no need for any further active elements in the vacuum cleaner. The feeder or the feeders can by way of example take the form of a flap, piston, screw, or nozzle. Dust binders can be added directly or by way of a valve.

In another embodiment, moldings of the invention are fed directly into the dust collection container, and the dust collection container together with the moldings is placed into the vacuum cleaner.

In another embodiment of the present invention, moldings are fed automatically into the dust collection container. In this process, certain proportions of dust binder are fed continuously and further feed of appropriate amounts takes place continuously. This type of automatic further feed can also be carried out as a function of the amounts of dust.

Dust collection containers can have any desired shape and any desired size, as a function of the type of vacuum cleaner. For the purposes of the present invention, dust collection containers can therefore have cubic, cylindrical, conical, or irregular shape. Examples of suitable volumes are from 0.1 dm³ to 2 dm³, but larger volumes up to 10 dm³ are also conceivable.

The form taken by the dust collection container can by way of example be that of a bag or of a box, or similar to that of a cyclone (centrifugal separator). The fill level of the dust collection container can by way of example be monitored electronically or mechanically, for example by sensors.

In another embodiment, in particular for bagless vacuum cleaners, the form taken by the dust collection container can be that of a box or similar to that of a cyclone.

In one embodiment of the present invention, the dust collection container comprises an apparatus for mixing, for example a mechanical apparatus, such as a stirrer, or a motor which sets the dust collection container in motion, for example vibrations or rotations. In another embodiment of the present invention, the dust collection container comprises no apparatus for mixing.

In one embodiment of the present invention, from 10 to 60% by volume of the dust collection container is filled with moldings of the invention, preferably from 25 to 50% by volume. In another embodiment of the present invention, at least one, preferably two to twenty, and in particular from two to five, of the moldings previously described are charged to a dust collection container.

In one embodiment of the present invention, moldings of the invention can bind up to 3000% by weight of dust, based on their own weight, for example from 500 to 3000% by weight. Dust-binding capability can by way of example be determined gravimetrically.

The present invention further provides vacuum cleaners, in particular bagless vacuum cleaners, comprising at least one molding described above.

Preference is given to bagless vacuum cleaners, comprising at least one, preferably two, moldings described above, also termed bagless vacuum cleaners of the invention below. During operation of the bagless vacuum cleaner of the invention, (a) molding(s) described above is/are kept in flotation together with the dust in the cyclone. In this application, the molding(s) of the invention operate(s) practically as dust binder (dust collector), in particular for fine dust, which can sometimes trigger allergies. Because dust and moldings of the invention are both kept in flotation, the dust particles adhere to moldings of the invention and thus lose their ability to move freely, and cannot therefore then raise a cloud of dust when the cyclone is emptied. Instead of this, they fall to the floor together with moldings of the invention. In this application, it is in essence the surface properties (adsorption) of the moldings of the invention that are used. Their advantageous filter properties are somewhat secondary in this instance.

It is also possible to use moldings of the invention in the fine-dust filter or as fine-dust filter, in order to prolong its operating time; the same applies to dust bags.

The present invention further provides a process for the cleaning of surfaces, in particular floors, by using vacuum cleaners of the invention, also termed cleaning process of the invention below. The procedure known per se can be used for conduct of the cleaning process of the invention. By virtue of the use of one or more vacuum cleaners of the invention, very clean exhaust air is produced and only a small amount of fine dust is raised.

Working examples are used to illustrate the invention. Testing in each of the working examples used “ground slate” mineral test dust with grain diameter range <200 μm and with 50% value <30 μm. However, other dust can also be used, examples being house dust, garden dust, sand, flour (kitchen dust), pollen, and carbon black.

### EXAMPLES

I. Production of Chemically Unmodified Foam

A spray-dried melamine/formaldehyde precondensate (molar ratio 1:3, molar mass about 500 g/mol) was added, in an open container, to an aqueous solution using 3% by weight of formic acid and 1.5% of the sodium salt of a mixture of alkyl sulfonates having from 12 to 18 carbon atoms in the alkyl radical (K 30 emulsifier from Bayer AG), where the percentages are based on the melamine/formaldehyde precondensate. The concentration of the melamine/formaldehyde precondensate, based on the entire mixture composed of melamine/formaldehyde precondensate and water, was 74% by weight. The mixture thus obtainable was vigorously stirred, and 20% by weight of n-pentane were then added. Stirring was continued for sufficient time (about 3 min) to produce a dispersion of homogeneous appearance. This was applied by doctoring to a Teflon-treated glass textile as backing, and foamed and cured in a drying oven in which the prevailing air temperature was 150° C. The temperature established here in the bulk of the foam was the boiling point of n-pentane, which under these conditions is 37.0° C. After from 7 to 8 min, the maximum rise height of the foam had been achieved. The foam was left for a further 10 min at 150° C. in the drying oven; it was then heat-conditioned at 180° C. for 30 min. This gave foam (F.1).

The following properties were determined on the foam (F.1):

99.6% open-cell to DIN ISO 4590,

compression hardness (40%) 1.3 kPa, determined to DIN 53577,

density 7.6 kg/m³, determined to EN ISO 845,

average pore diameter 210 μm, determined by evaluating micrographs of sections,

BET surface area 6.4 m²/g, determined to DIN 66131,

sound absorption 93%, determined to DIN 52215,

sound absorption more than 0.9, determined to DIN 52212.

II. Production of Moldings Used in the Invention

Moldings were stamped out from a piece of foam (F.1) using a hammer and wad punch: cylinders with a diameter of 5 mm and a height of 1 cm (M.1) and cylinders with a diameter of 10 mm and a height of 3 cm (M.2).

III. Use as Dust Binders

A molding (M.1) and 40 g of “ground slate” mineral test dust were charged to a cyclone with the following external dimensions: height=260 mm, diameter=150 mm, and fluidized by an air stream of velocity 20 m/s over a period of one minute. The mineral test dust particles here collided with the molding and were adsorbed. The increase in weight of the molding loaded with mineral test dust was then determined gravimetrically. The weight of molding (M.1) was found to have increased by approximately a factor of 3. Light-scattering methods led to further conclusions in relation to the particle diameters of adsorbed mineral test dust (see Table 1) and chemical constitution (inorganic or organic).

The experiment was repeated, but molding (M.2) replaced molding (M.1). The increase in weight found for molding (M.2) after the fluidization process was 900%.

Moldings (M.1) and (M.2) exhibited good dust binding capability.

TABLE 1
Particle diameter distribution of adsorbed mineral test dust on
molding (M.2), rel. increase in weight of specimen: 9-fold

| Grain size limit [μm] | Percent by weight |
|---|---|
| 0.5-1 | 48.75 |
| 1-2 | 31.55 |
| 2-3 | 8.04 |
| 3-4 | 5.30 |
| 4-5 | 3.01 |
| 5-6 | 1.63 |
| 6-150 | 1.72 |

1. A molding with length·width·height dimensions respectively in the range from 1 mm to 3 cm as dust binders in vacuum cleaners, where the molding has been produced from chemically untreated open-cell foam having a density in the range from 5 to 500 kg/m³ and an average pore diameter is in the range from 1 μm to 1 mm.

2. The molding according to claim 1, wherein open-cell foams comprises foams of synthetic organic foam.

3. The molding according to claim 1, wherein the open-cell foam comprises a polyurethane foam or a aminoplastic foam.

4. The molding according to claim 1, wherein for the production of the moldings, a shaping step selected from laceration, stamping, or cutting is carried out.

5. A vacuum cleaner, comprising at least one molding with length·width·height dimensions respectively in the range from 1 mm to 3 cm, where the molding has been produced from chemically untreated open-cell foam having a density in the range from 5 to 500 kg/m³ and an average pore diameter in the range from 1 μm to 1 mm.

6. A process for the cleaning of surfaces, using at least one vacuum cleaner according to claim 5.

7. The molding according to claim 1, shaped by a process comprising at least one of lacerating said molding, stamping said molding, and cutting said molding.

8. A vacuum cleaner comprising the molding according to claim 1.

9. A process for cleaning a substrate, comprising contacting the surface with at least one vacuum cleaner according to claim 5.

10. A process for cleaning a substrate, comprising contacting the surface with at least one vacuum cleaner according to claim 8.
